(19) United States
(12) Patent Application Publication
(10) Pub. No.: US 2014/0195587 A1
(43) Pub. Date: Jul. 10, 2014

(54) METHOD AND SYSTEM FOR PROVIDING DIGITAL CONTENT

(71) Applicant: SOOKBOX LLC, Cambridge, MA (US)

(72) Inventors: David Sukoff, Bedford, MA (US); Cyrus Vafadari, Boston, MA (US); Mathew Peterson, Boston, MA (US)

(73) Assignee: SookBox LLC, Cambridge, MA (US)

(21) Appl. No.: 13/734,511

(22) Filed: Jan. 4, 2013

(51) Int. Cl. H04L 29/06

(52) U.S. Cl. CPC H04L 67/42
USPC 709/203

(57) ABSTRACT

A method for managing and distributing media content in a network system includes receiving a request from a control device to deliver at least one item of digital content through the network system from the host server. The method also includes providing the control device with status information associated with the digital content and a plurality of outputs of the host server connected to the network system in response to receiving the request. The method includes receiving a command from the control device to serve the at least one item of digital content or the status information associated with the digital content or the status information for the plurality of outputs of the host server via a selected output. Further, the method includes serving the at least one item of digital content or the status information via the selected output in response to receiving the command from the control device.

### BACKGROUND

A recent trend with respect to consumer electronic devices is that they have become increasingly affordable. In addition, the consumer electronic devices increasingly include more advanced features. These features allow homeowners to enhance their home entertainment user experience.

As consumer electronic devices continue to become more available and improved for the user, the user's desire to access various types of digital content provided by various digital content sources (providers) also continues to grow.

Currently, users access to digital content, such as DVDs or CDs, in the home is limited to one location or zone of the user's home. Additionally, in this paradigm it is increasingly difficult for users to view content, such as DVD movies, simultaneously in various locations (zones) within their home. Users are increasingly able to access digital content from content service provides.

For example, if a user subscribes to subscription service such as Netflix®, they typically only view these movies on a consumer electronic device such as, for example, an internet television or multimedia player that already has that application pre-installed. In addition, the consumer electronic device needs to have internet access. Furthermore, even if internet access is available there often is bandwidth, resolution, synchronization constraints associated with streaming digital content such as, but not limited to, movies externally from a wide area network (WAN) either to one television or simultaneously to multiple televisions throughout the home.

### SUMMARY

Embodiments of the present disclosure include methods, systems, or computer readable medium, with program codes embodied thereon, for managing and distributing media content in a network system. One embodiment is a method that includes receiving a request from a control device to deliver at least one item of digital content stored on a host server through the network system from the host server. The method also includes providing the control device with status information associated with the digital content and status information for a plurality of outputs of the host server connected to the network system in response to receiving the request. Also, the method includes receiving a command from the control device to serve the at least one item of digital content or the status information associated with the digital content or the status information for the plurality of outputs of the host server via a selected output. The selected output is selected by a user of the control device based on at least the status information associated with the plurality of outputs connected to the network system. Further, the method includes serving the at least one item of digital content or the status information via the selected output in response to receiving the command from the control device.

The method can also include authorizing the control device to communicate with the host server connected to the network system in response to receiving an initialization request from the control device. In addition, the method can include providing the control device with a list of the digital content stored on the host server connected to the network system.

The method can further include associating each of the plurality of outputs with a corresponding unique identifier. The control device can be one control device among a plurality of control devices. In another embodiment, the method can include monitoring status information of each of the plurality of outputs and the digital content. To further this embodiment, this includes real-time updating. In the embodiment, the method also includes maintaining the status information associated with each of the plurality of outputs and the digital content in a data store and providing the plurality of control devices with the status information. Providing the status information can include simultaneously providing the status information to the plurality of control devices.

The method can include receiving the request from the control device agnostic to a location of the control device with respect to the host server connected to the network system. The control device can be a transmit/receive unit (TRU) capable of communicating with devices on the network system. Each of the plurality of outputs can be an audio output, display output, or audio and display output.

Further, the method can include changing a presentation state of at least one item of the digital content being served via the selected output in response to receiving a command from the control device to change the presentation state of the item of the digital content. The method can also include changing a presentation state of at least one output of the plurality of outputs via which digital content is being served in response to receiving a command from the control device to change the presentation state of the one output.

Another embodiment of the disclosure is a host server for managing and distributing media content in a network system. The host server includes one or more processors and a memory. In addition, the host server includes a web server module configured to receive, using the one or more processors, a request from a control device to deliver at least one item of digital content stored in the memory of the host server through the network system from the host server. Also, the host server includes a zone manager configured to provide, using the one or more processors, the control device with status information associated with the digital content and status information for a plurality of outputs of the host server connected to the network system in response to receiving the request.

The web server module is further configured to receive, using the one or more processors, a command from the control device to serve the at least one item of digital content or the status information associated with the digital content or the status information for the plurality of outputs of the host server via a selected output, the selected output being selected by a user of the control device based on at least the status information associated with the plurality of outputs connected to the network system. In addition, the zone manager is further configured to serve, using the one or more processors, the at least one item of digital content or the status information via the selected output in response to receiving the command from the control device.

The web server module can be further configured to authorize, using the one or more processors, the control device to communicate with the host server connected to the network system in response to receiving an initialization request from the control device.

The zone manager can also be further configured to provide, using the one or more processors, the control device with a list of the digital content stored on the host server connected to the network system. Also, the zone manager can be configured to associate, using the one or more processors, each of the plurality of outputs with a corresponding unique identifier. The control device can be one control device among a plurality of control devices.

In addition, the zone manager, using the one or more processors, can be further configured to monitor status information of each of the plurality of outputs and the digital content, maintain the status information associated with each of the plurality of outputs and the digital content in the memory, and provide the plurality of control devices with the status information. Also, the zone manager can be further configured to simultaneously provide, using the one or more processors, the status information to the plurality of control devices.

The web server module can be further configured to receive the request from the control device agnostic to a location of the control device with respect to the host server connected to the network system. The control device can be a transmit/receive unit (TRU) configured to communicate with devices on the network system.

Each of the plurality of outputs can be an audio output, display output, or audio and display output.

The zone manager, using the one or more processors, can be further configured to change a presentation state of the item of the digital content being served via the selected output in response to receiving a command from the control device to change the presentation state of the item of the digital content. Also, the zone manager, using the one or more processors, can be configured to change a presentation state of one output of the plurality of outputs via which digital content is being served in response to receiving a command from the control device to change the presentation state of the one output.

Another example embodiment of the present disclosure includes a non-transitory computer readable medium having computer readable program codes embodied therein for managing and distributing media content in a network system, the computer readable program codes including instructions that, when executed by a processor, cause the processor to receive a request from a control device to deliver at least one item of digital content stored on a host server through the network system from the host server. In addition, the code causes the processor to provide the control device with status information associated with the digital content and status information for a plurality of outputs of the host server connected to the network system in response to receiving the request. The code also causes the processor to receive a command from the control device to serve the at least one item of digital content or the status information associated with the digital content or the status information for the plurality of outputs of the host server via a selected output, the selected output being selected by a user of the control device based on at least the status information associated with the plurality of outputs connected to the network system. Further, the code causes the processor to serve the at least one item of digital content or the status information via the selected output in response to receiving the command from the control device.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 illustrates an example environment of a home network system.

FIG. 2 illustrates an example environment of a home network system in accordance with an example embodiment of the present disclosure.

FIG. 3 is a schematic block diagram of a host utilized by a home network system in accordance with an example embodiment of the present disclosure.

FIG. 4 is a flow diagram of a method for obtaining zone state information from a host by a user via a control device, in an example embodiment of the present disclosure.

FIG. 5 is a flow diagram of a method for streaming digital content from a host to an output device in accordance with an example embodiment of the present disclosure.

### DETAILED DESCRIPTION

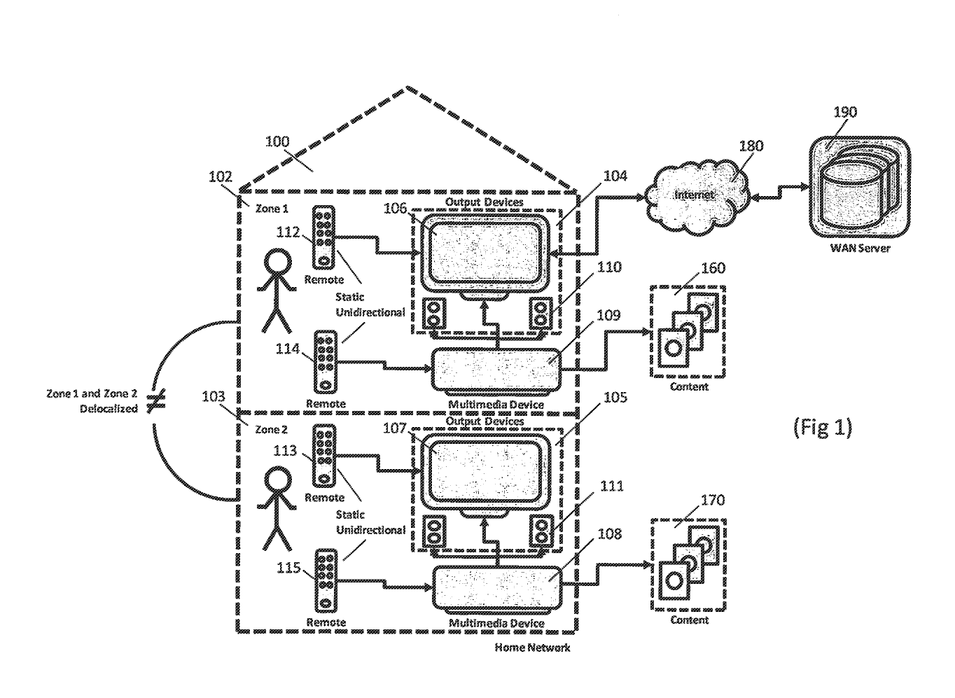

FIG. 1 illustrates an example environment of a home network system 100. The example environment includes a home network system 100 that includes two delocalized zones (e.g., locations) 102, 103 for providing content 160. Each zone (e.g., Zone 1 (102) and Zone 2 (103)) includes respective consumer electronic devices (e.g., output devices 104, 105). The output devices 104, 105 can include any configuration of display devices 106, 107 and/or audio devices 110, 111 known or yet to be known in the art. Each of the output devices 104, 105 are connected to respective multimedia devices 108, 109 that are used to provide content 160, 170 to the user via the output devices 104, 105. The display devices can include, for example, LCD, LED, Plasma, and CRT monitors. The multimedia devices 108, 109 can include, but are not limited to, DVD players, digital video recorders (DVRs), cable-top-boxes, media/content streaming devices (e.g., Apple TV® and Boxee®).

In this example, output device 104 includes a smart television 106 that is able to obtain content from a wide area network server 190 via a connection to the internet 180. However, the connection to the internet 180 must be readily available in the zone in which the television 106 is located. For instance, the television 106 must have the ability to have a wired/wireless internet connection. Such a requirement can limit the location a user of the television 106 may place the television 106.

As illustrated, each of the output devices 104, 105 are controlled by respective remote control devices 112-115. Typical remote control devices 112-115 are static and unidirectional in nature. This typically means that the remote control devices 112-115 are only designed to transmit commands to their native devices (i.e., a device for which a remote control device is manufactured to operate/control). Also, such remote control devices 112-115 are unidirectional because they are incapable of receiving information. Because the remote control devices 112-115 are incapable of receiving information, the remote control devices 112-115 are not trainable and generally cannot be upgraded beyond their original design.

In another example, any one of the remote control devices 112-115 may be a universal remote. Such remotes are used to integrate control of several output devices. Universal remotes generally only integrate features that are common to most output devices (e.g., ON/OFF, volume, and channel control.) However, output devices are becoming more advanced and include functions specific to a certain make/model. Thus, such universal remotes cannot control the full plurality of features of all output devices to the same level as is possible with a dedicated remote control device for a particular output device. Thus, in order to have remote control of the full plurality of features of the output devices, users of the output devices generally still need to have easy access to the dedicated remote control devices.

A drawback of the home network system 1 is that the consumer output devices 104, 105 are generally singularly connected to each other (for example, one multimedia device 109 is connected to one television 106). Also, the consumer output devices 104, 105 are typically only operable within a specific zone of the home. For instance, the electronic devices are able to operate in a single zone and are unable to operate in other locations (e.g., zones) or in conjunction with other electronic devices in other zones within the home. Thus, a user cannot operate the output devices 4 located in Zone 1 (102) using a remote control device 113, 115 from Zone 2 (102).

Embodiments of the present disclosure relate to systems, methods, and apparatuses for connecting output devices delocalized from each other. Additional embodiments of the present disclosure relate to systems, methods, and apparatuses for controlling, from any location, the output devices that are delocalized from each other.

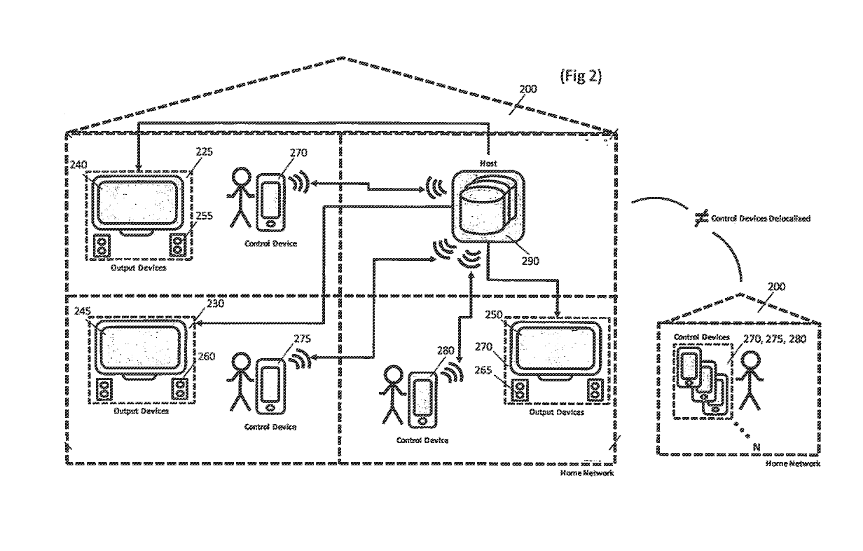

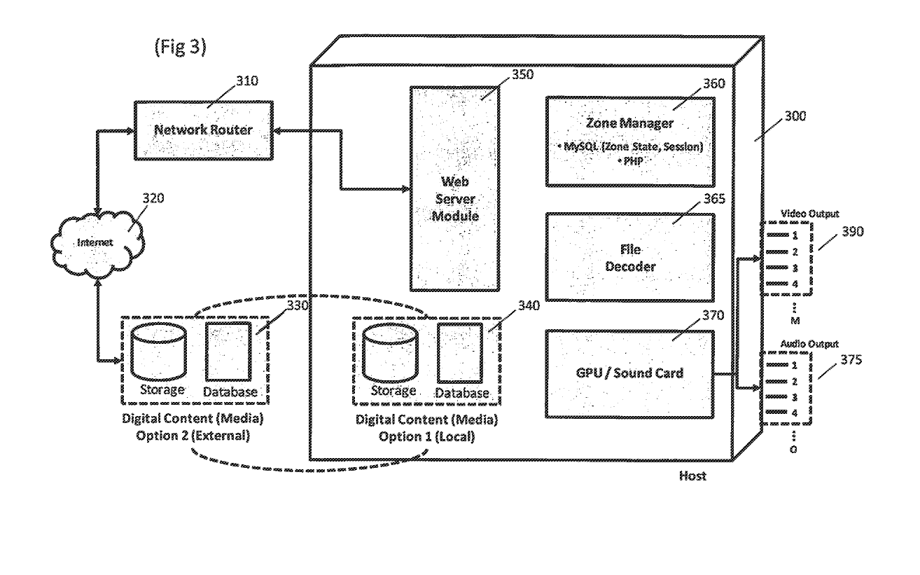

FIG. 2 illustrates an example environment of a home network system 200, according to an illustrative embodiment of the present disclosure. The home network system 200 includes various output devices 225, 230, 270 containing display devices 240, 245, 250 and/or audio devices 255, 260, 265, various control devices 270, 275, 280, and a host 290. In an example embodiment, each of the output devices 225, 230, 270 are connected to corresponding outputs (e.g. outputs 2905 and 390 of FIG. 3) of the host 290.

Each of the devices is communicatively connected to each other. Any suitable wired/wireless connectivity technologies mentioned herein can be employed to facilitate connection between any of the various control devices 270, 275, 280, various output devices 225, 230, 270, and the host 290.

The control devices 270, 275, 280 and host 290 can communicate with each other by exchanging data packets according to a pre-defined set of network protocols, such as the Transmission Control Protocol/Internet Protocol (TCP/IP), the Real-time Transport Protocol (RTP), the User Datagram Protocol (UDP). A network protocol as used herein is a formal set of rules that define how data is exchanged between nodes (e.g., the control devices 270, 275, 280 and host 290) in a communications network.

The control devices 270, 275, 280 can be conventional communication units, such as laptop computers, desktop computers, wireless transmit/receive units (WTRUs) (e.g., smart phones and personal digital assistants (PDAs), and the like, that convert information (e.g., data) into signals that are transferred to an access point (e.g., network router 44 of FIG. 3) of the host 290 via wireless and wired links. More specifically, the control devices 270, 275, 280 are devices are configured to connect to the home network system 200 and communicate with devices on the home network system 200. The home network system 200 can be, for example, a local area network (LAN).

The access point contains logic that enables the control devices 270, 275, 280 to transmit the information (e.g., data) to the host 290. For example, access point can include circuitry configured to receive signals (e.g., radio frequency (RF) signals), from the control devices 270, 275, 280, that carry the information via wireless and wired links. Once the signals are received, the access point converts the signals into data packets according the predefined set of network protocols. The access point then passes the data packets to the host 290. The host 290 then processes the data packets to control and provide digital content to a user via output devices 225, 230, 270. In addition, the access point enables the host 290 to connect to a wired/wireless local area network (e.g., the home network system 200).

The host 290 includes at least one interface (e.g., outputs 375 and 390 of FIG. 3) by which the output devices 225, 230, 270 are connected to the host 290. In an example, the host 290 can include a plurality of audio output interfaces, a plurality of video interfaces, and a plurality of audio and video interfaces. The host 290 assigns each of the interfaces a corresponding unique identifier. Based on a type of the at least one interface, the unique identifier corresponding to the at least one interface includes information associated with a type of output device connected to the interface (e.g., audio and/or video device).

The output devices 225, 230, 270 can be connected to the interfaces of the host via a High-Definition Multimedia Interface (HDMI) cable. HDMI is a compact audio/video interface for transferring uncompressed video data and compressed/uncompressed digital audio data from an HDMI-complaint device to a compatible digital audio device or digital television. In another example, the output devices can be connected to the host via a wireless HDMI connectivity technology such as, for example, Sony Bravia Wireless Link® utilizing, for example, a Wireless Home Digital Interface (WHDI) protocol standard for wireless HDTV connectivity that enables delivery of uncompressed high-definition video over a wireless radio channel connecting any video source (e.g., computers, mobile phone, Blu-ray players) to any compatible display device.

As stated above the output devices 225, 230, 270 can include display devices 240, 245, 250. The display devices 240, 245, 250 can be, for example, older generation televisions (e.g., cathode ray tube (CRT) televisions), internet enable televisions, LEDs, LCD, mobile phones, smart-phones, computers, laptops, notebooks, and tablets. More specifically, these display devices 240, 245, 250 are any device capable of displaying digital content to be viewed by a user.

Also, as stated above the output devices 225, 230, 270 can include audio devices 255, 260, 265. The audio devices 255, 260, 265 can be, for example, speakers and headphones. More specifically, the audio devices 255, 260, 265 are devices capable of playing any type of audio content such that a user is able to hear the audio content. The audio devices 255, 260, 265 can reside within various zones of a home network independent of the respective display devices 28-30.

In addition, the host 290 includes a storage device that is configured to store digital content. Digital content generally refers to information available for download or distribution on electronic media. For example, the digital content can include, but is not limited to, video, audio, digital media, documents, photos, or any other dynamically generated information. The digital content can be in several known formats such as, for example, mp3, MPEG, DIVX, MOV, JPEG, and WAV. A user may access the host 290 via the local area network and upload digital content to the host 290. In another example, the user may access the host 290 and download digital content from an external source (e.g., the Internet) to the host 290.

In order to access the digital content, the user utilizes the control devices 270, 275, 280 to communicate with the host 290. The control devices 270, 275, 280 obtain a communication address of the host 290 (e.g., an IP address). For example, a user of the control devices 270, 275, 280 can register at least one of the control devices 270, 275, 280 to communicate/access the host 290. The user may register the control devices 270, 275, 280 by signing into a central server (not shown) using authentication information (e.g., username/password) of the user and associate the at least one of the control devices 270, 275, 280 with the host 290. Once the at least one of the control devices 270, 275, 280 is registered, the at least one of the control devices 270, 275, 280 is able to communicate/access the host 290 using the IP address of the host 290 provided to the control devices 270, 275, 280 in response to registering with the central server. The control devices 270, 275, 280 are able to communicate with the host 290 via the access point. Advantageously, the ability of the control devices 270, 275, 280 to communicate with the host 290 is agnostic to the physical location of the control devices 270, 275, 280 with respect to the host 290. In particular, the control devices 270, 275, 280 are able to communicate with the host 290 as long as the control devices 270, 275, 280 are able to send communication signals to the access point associated with the host 290.

Once the user is connected to the host 290 via one of the control devices 270, 275, 280, the host 290 provides the user with a list of the digital content stored on the host 290. Once the user selects a specific item of the digital content, the host 290 provides the user with an option as to which of the output devices 225, 230, 270 from which the user would like the selected digital content presented. For example, the host 290 presents the user with a list of output devices 225, 230, 270 using the unique identifiers associated with the interfaces by which the output devices 225, 230, 270 are connected to the host 290. The user can then select one of the output devices 225, 230, 270. The option of output devices 225, 230, 270 presented to the user may be based on a current status of the output devices and/or the type of digital content requested by the user. For example, if the user wished to watch a movie and two of the zones of home network system 20 are being utilized by other users, the host 290 presents the user with an output device in a zone of the home network system that is in an inactive state as on option for playing the selected digital content.

FIG. 3 is a schematic block diagram of a host 300 utilized by a home network system (e.g., the home network system 200 of FIG. 2). The host 300 can include, but is not limited to, a network router 310, web server module 350, zone manager 360, file decoder 365, GPU/soundcard 370, digital content storage/database 330, 340 and audio output interface 375 video output interface 390. Any suitable connectivity technologies mentioned herein may be employed to facilitate connection between the various devices 350-375.

The network router 310 is configured to function as a wireless access point. The router 310 provides the host 300 with a connection to the internet 320. More specifically, the router 310 can function in a wired local area network (LAN), wireless-only LAN (WLAN), or in a mixed wired/wireless network. As stated above, the network router 310 enables the control devices 270, 275, 280 to communicate with the host 300.

The web server module 350 is configured to enable the host 300 to deliver digital content to devices connected to a local area network (LAN) (e.g., the home network system 200 of FIG. 2). In addition, the web server module 350 processes communications received from the LAN via the network router 310. Using the web server module 350, the host 300 is able to communicate with and manage devices connected to the LAN. For example, the web server module 350 communicates with the control devices 270, 275, 280, zone manager 360, and file decoder in order to manage and provide the digital content stored in the digital content storage/database 330, 340.

The zone manager 360 communicates with the web server module 350 to determine all output devices (e.g., output devices 225, 230, 270 of FIG. 2) connected to the LAN via the network router 310. In addition, the zone manager 360 can identify all output devices (e.g., output devices 225, 230, 270 of FIG. 2) connected to the host 300 via the video output interface 390 and/or the audio output interface 375. The zone manager 360 also associates the video output interface 390 and the audio output interface 375 with a unique identifier. It should be noted that the host 300 can also include additional audio output interfaces, video output interfaces, and audio and video output interfaces.

Once all the output interfaces 375, 390 are been identified and associated with a unique identifier, the zone manager 360 monitors the status of all the output interfaces 375, 390. The zone manager performs this task by monitoring traffic flow from each of the output interfaces 375, 390. In addition, the zone manager 360 determines that status of the digital content stored by the host 300 via the digital content storage/database 330, 340. For instance, the zone manager 360 determines whether an item of digital content is currently being served via one of the output interfaces 375, 390.

In an example embodiment, the web server module 350 receives a request for an item of digital content from a control device (e.g., the control device 270 of FIG. 2) via the network router 310. In addition, the web server module 350 receives a corresponding command that that identifies from which of the output interfaces 375, 390 to serve the digital content. The web server module 350 passes the request and corresponding command are passed to the file decoder 265. The file decoder 365 retrieves the selected digital content from the digital content storage/database 330, 340 and processes and formats the digital content for standardization into the GPU/Soundcard 370 similar to, but not limited to, as that of either a web browser or VLC.

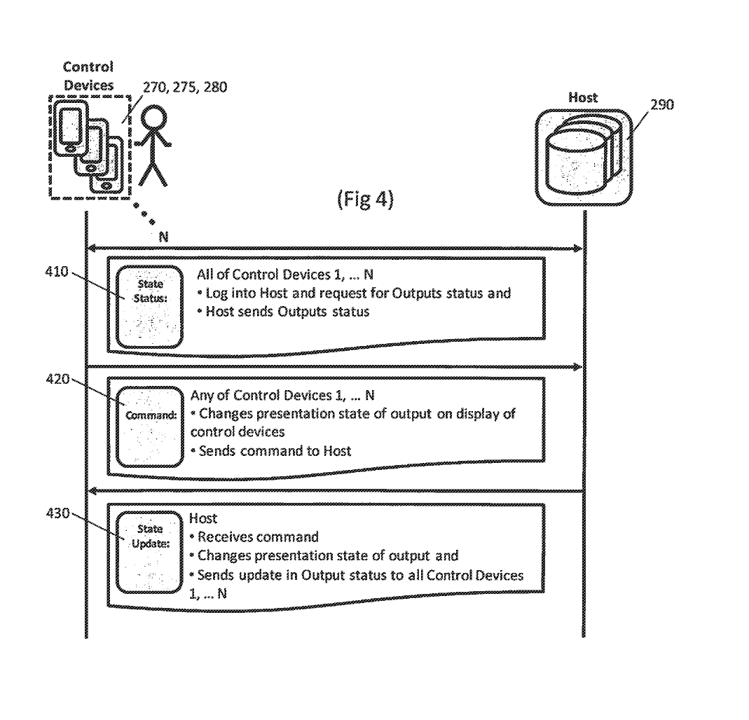

FIG. 4 is a flow diagram of a method for obtaining state information from a host 290 by a user via one of the control devices 270, 275, 280. At 410, the control devices 270, 275, 280 log into the host 290 and request status information associated with each of the outputs of the host 290 (e.g., output interfaces 375, 390 of FIG. 3). In response to receiving the request, the host 290 sends the status information to the control devices 270, 275, 280.

At 420, in response to receiving the status information, the control devices 270, 275, 280 update the status of each of the outputs of the host 290 on a user interface (e.g., display) of the control devices 270, 275, 280. In addition, a user of the control devices 270, 275, 280 sends a command to the host 290 to change a state of one of the outputs of the host 290. For example, the user may wish to watch a different movie or listen to a different music file. In such a scenario, the user sends a command via the control devices 270, 275, 280 to the host 290 for the host 290 to serve the different movie or music file via one of the outputs.

At 430, the host 290 receives the command. In response to receiving the command, the host 290 changes the presentation state of an output of the host 290 identified in the command.

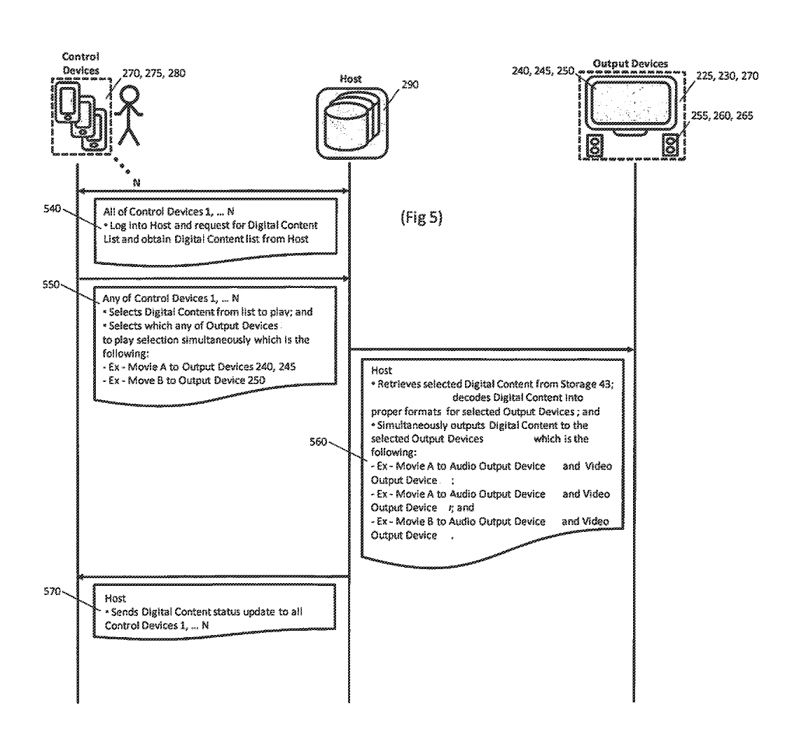

FIG. 5 is a flow diagram of a method for streaming digital content from a host 290, 38 to at least one of a plurality of output devices 225, 230, 270. At 540, the control devices 270, 275, 280 log into the host 290 and request a list of digital content accessible via local/remote storage devices to the host 290. In response to receiving the request, the host 290 serves the control devices 270, 275, 280 with the list of digital content. At 550, a user of any of the control devices 270, 275, 280 selects an item of digital content from the list of digital content for the host 290 to serve to the user. In addition, the user selects any of the output devices 240, 245, 250 from which the user wished the item of digital content to be presented. In response to the user selections, a control device the user is controlling (e.g., control device 270) sends a request for the item of digital content to the host 290. In addition, the control device 270 sends a command to the host 290 that identified an output interface of the host 290 from which the host 290 is to serve the item of digital content. For example, one user may wish to watch “Movie A” via output devices 240, 245.

In this example, at 560, the host receives the request and command from the control device 270. A web server module (e.g., the web server module 350 of FIG. 3) receives the request and command and passes them to a zone manager (e.g., the zone manager 360 of FIG. 3). The zone manager processes the request and command and instructs a file decoder (e.g., the file decoder 365 of FIG. 3) to retrieve the requested item of digital content from storage (e.g., the digital content storage/database 330, 340). Once the file decoder retrieves the requested item of digital content, the file decoder decodes the digital content in a format corresponding to the output interface of the host 290 from which the host 290 is to serve the requested item of digital content to the user. The zone manager then simultaneously serves the digital content to all output interfaces identified in the received command. At 570, the host 290 sends updated status information to all control devices 270, 275, 280 that are registered with the host 290.

Further example embodiments of the present disclosure may be configured using a computer program product; for example, controls may be programmed in software for implementing example embodiments of the present disclosure. Further example embodiments of the present disclosure may include a non-transitory computer readable medium containing instruction that may be executed by a processor, and, when executed, cause the processor to complete methods described herein. It should be understood that elements of the block and flow diagrams described herein may be implemented in software, hardware, firmware, or other similar implementation determined in the future. In addition, the elements of the block and flow diagrams described herein may be combined or divided in any manner in software, hardware, or firmware. If implemented in software, the software may be written in any language that can support the example embodiments disclosed herein. The software may be stored in any form of computer readable medium, such as random access memory (RAM), read only memory (ROM), compact disk read only memory (CD-ROM), and so forth. In operation, a general purpose or application specific processor loads and executes software in a manner well understood in the art. It should be understood further that the block and flow diagrams may include more or fewer elements, be arranged or oriented differently, or be represented differently. It should be understood that implementation may dictate the block, flow, and/or network diagrams and the number of block and flow diagrams illustrating the execution of embodiments of the disclosure.

Procedure or method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Subroutines and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Computer program products suitable for embodying computer program instructions and data include all forms of non-volatile memory, including by way of example semiconductor memory devices. The computer program products can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques and approaches can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques and approaches can be implemented in a distributed computing system that includes a back-end component. The back-end component can, for example, be a data server, a middleware component, and/or an application server. The above described techniques and approaches can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth, code-division multiple access (CDMA) network, time division multiple access (TDMA) network, global system for mobile communications (GSM) network), and/or other circuit-based networks.

One skilled in the art will realize the disclosure may be embodied in other specific forms without departing from the spirit or essential characteristics thereof. The foregoing embodiments are therefore to be considered in all respects illustrative rather than limiting of the disclosure described herein. Scope of the disclosure is thus indicated by the appended claims, rather than by the foregoing description, and all changes that come within the meaning and range of equivalency of the claims are therefore intended to be embraced therein.

1. A method of managing and distributing media content in a network system, the method comprising:
receiving a request from a control device to deliver at least one item of digital content stored on a host server through the network system from the host server;
providing the control device with status information associated with the digital content and status information for a plurality of outputs of the host server connected to the network system in response to receiving the request;
receiving a command from the control device to serve the at least one item of digital content or the status information associated with the digital content or the status information for the plurality of outputs of the host server via a selected output, the selected output being selected by a user of the control device based on at least the status information associated with the plurality of outputs connected to the network system; and
serving the at least one item of digital content or the status information via the selected output in response to receiving the command from the control device.

2. The method of claim 1, further comprising authorizing the control device to communicate with the host server connected to the network system in response to receiving an initialization request from the control device.

3. The method of claim 1, further comprising providing the control device with a list of the digital content stored on the host server connected to the network system.

4. The method of claim 1, further comprising associating each of the plurality of outputs with a corresponding unique identifier.

5. The method of claim 1, wherein the control device is one control device among a plurality of control devices.

6. The method of claim 5, further comprising:
monitoring status information of each of the plurality of outputs and the digital content;
maintaining the status information associated with each of the plurality of outputs and the digital content in a data store; and
providing the plurality of control devices with the status information.

7. The method of claim 6, wherein providing the status information includes simultaneously providing the status information to the plurality of control devices.

8. The method of claim 1, wherein receiving the request from the control device is agnostic to a location of the control device with respect to the host server connected to the network system.

9. The method of claim 1, wherein the control device is a transmit/receive unit (TRU) capable of communicating with devices on the network system.

10. The method of claim 1, wherein each of the plurality of outputs are an audio output, display output, or audio and display output.

11. The method of claim 1, further comprising changing a presentation state of at least one item of the digital content being served via the selected output in response to receiving a command from the control device to change the presentation state of the item of the digital content.

12. The method of claim 1, further comprising changing a presentation state of at least one output of the plurality of outputs via which digital content is being served in response to receiving a command from the control device to change the presentation state of the one output.

13. A host server for managing and distributing media content in a network system, the host server comprising:
one or more processors;
a memory;
a web server module configured to receive, using the one or more processors, a request from a control device to deliver at least one item of digital content stored in the memory of the host server through the network system from the host server;
a zone manager configured to provide, using the one or more processors, the control device with status information associated with the digital content and status information for a plurality of outputs of the host server connected to the network system in response to receiving the request;
the web server module further configured to receive, using the one or more processors, a command from the control device to serve the at least one item of digital content or the status information associated with the digital content or the status information for the plurality of outputs of the host server via a selected output, the selected output being selected by a user of the control device based on at least the status information associated with the plurality of outputs connected to the network system; and
the zone manager further configured to serve, using the one or more processors, the at least one item of digital content or the status information via the selected output in response to receiving the command from the control device.

14. The host server of claim 13, wherein the web server module is further configured to authorize, using the one or more processors, the control device to communicate with the host server connected to the network system in response to receiving an initialization request from the control device.

15. The host server of claim 13, wherein the zone manager is further configured to provide, using the one or more processors, the control device with a list of the digital content stored on the host server connected to the network system.

16. The host server of claim 13, wherein the zone manager is further configured to associate, using the one or more processors, each of the plurality of outputs with a corresponding unique identifier.

17. The host server of claim 13, wherein the control device is one control device among a plurality of control devices.

18. The host server of claim 17, wherein the zone manager, using the one or more processors, is further configured to:
monitor status information of each of the plurality of outputs and the digital content;
maintain the status information associated with each of the plurality of outputs and the digital content in the memory; and
provide the plurality of control devices with the status information.

19. The host server of claim 18, wherein the zone manager is further configured to simultaneously provide, using the one or more processors, the status information to the plurality of control devices.

20. The host server of claim 13, wherein the web server module is further configured to receive the request from the control device agnostic to a location of the control device with respect to the host server connected to the network system.

21. The host server of claim 13, wherein the control device is a transmit/receive unit (TRU) configured to communicate with devices on the network system.

22. The host server of claim 13, wherein each of the plurality of outputs are an audio output, display output, or audio and display output.

23. The host server of claim 13, wherein the zone manager, using the one or more processors, is further configured to change a presentation state of at least one item of the digital content being served via the selected output in response to receiving a command from the control device to change the presentation state of the item of the digital content.

24. The host server of claim 13 wherein the zone manager, using the one or more processors, is further configured to change a presentation state of at least one output of the plurality of outputs via which digital content is being served in response to receiving a command from the control device to change the presentation state of the one output.

25. A non-transitory computer readable medium having computer readable program codes embodied therein for managing and distributing media content in a network system, the computer readable program codes including instructions that, when executed by a processor, cause the processor to:
receive a request from a control device to deliver at least one item of digital content stored on a host server through the network system from the host server;
provide the control device with status information associated with the digital content and status information for a plurality of outputs of the host server connected to the network system in response to receiving the request;
receive a command from the control device to serve the at least one item of digital content or the status information associated with the digital content or the status information for the plurality of outputs of the host server via a selected output, the selected output being selected by a user of the control device based on at least the status information associated with the plurality of outputs connected to the network system; and
serve the at least one item of digital content or the status information via the selected output in response to receiving the command from the control device.
